(19) United States
(12) Patent Application Publication
(10) Pub. No.: US 2020/0299048 A1
(43) Pub. Date: Sep. 24, 2020

(54) Device for Protecting an Inner Container

(71) Applicant: Biomedical Regenerative GF, LLC, Boca Raton, FL (US)

(72) Inventor: Claudia Santamaria, Boca Raton, FL (US)

(21) Appl. No.: 16/607,641

(22) PCT Filed: May 8, 2018
(86) PCT No.: PCT/US2018/031704

§ 371 Date: Oct. 23, 2019

Related U.S. Application Data
(60) Provisional application No. 62/503,219, filed on May 8, 2017.

(51) Int. Cl. B65D 77/04; B65D 77/00; B65D 81/05

(52) U.S. Cl. CPC B65D 77/0493; B65D 77/003; B65D 2581/056; B65D 2581/055; B65D 81/05

(57) ABSTRACT

A device for protecting an inner container and the sample or contents in the inner container. The device for protecting an inner container and sample includes an inner container and an outer protective body. The inner container can receive a sample for applications such as biomedical, health care, dentistry, agricultural, industrial, and veterinary. The inner container can be received into the outer protective body for protection. A lid secures over the inner container forming a seal to prevent leakage and contamination of the sample or inner container contents. The outer protective body is breakage-resistant for protection if the apparatus is dropped.

### CROSS REFERENCE TO RELATED APPLICATION

This application claims priority to and the benefit of U.S. provisional application No. 62/503,219, filed on May 8, 2017 in its entirety. This application is the national stage application from international application number PCT/US2018/031704, having an international filing date of May 8, 2018 and which claims priority to U.S. provisional application No. 62/503,219.

### FIELD OF THE DISCLOSURE

The present disclosure relates to health care equipment and devices for protecting inner containers. More specifically, the present disclosure relates to devices for protecting containers capable of holding fluid specimens for storage, analysis, or processing in medical, pharmaceutical, clinical, forensic, dental, industrial, agricultural, environmental, and veterinary applications.

### BACKGROUND OF THE DISCLOSURE

In the biomedical science and health care industries in particular, blood is drawn for various tests to assess an animal's health. Test tubes or storing, transporting, and processing blood may have an additive for either promoting or inhibiting clotting, depending on the intended application. From the blood sample, the intended application may require the testing or processing of serum or plasma. To accomplish this, the blood is disposed in a test tube with an additive.

Modern blood collection tubes and test tubes are made from plastic, requiring treatment with an additive, especially in applications requiring centrifugation to obtain a serum or plasma supernatant. Plastic is almost exclusively used due to the risks that glass test and blood collection tubes pose: breakage, contamination of the sample, contamination of the laboratory, contamination and injury of the personnel handling the sample, and the spread of blood-borne pathogens and diseases. The test and blood collection tube materials, additives, and specifications are therefore regulated by governing agencies such as the U.S. Food and Drug Administration which generally requires the use of plastic test and blood collection tubes.

Traditionally, blood collection tubes were made out of glass, particularly in the mid 1900's. Glass tubes did not require a clotting additive because the silica in glass already promoted clotting. The blood cells and platelets would coagulate, and during centrifugation would fall to the bottom of the tube, leaving a supernatant of serum or plasma.

Glass test tubes and blood collection tubes are ideal for biomedical and health care applications requiring the retrieval of plasma or serum. Newer regenerative treatments with platelet-rich plasma and platelet-rich fibrin for example require drawing a person's blood, spinning the sample down in a centrifuge, retrieving a supernatant, and treating the person with the supernatant that may or may not be further processed. These applications are distinguished from drawing blood merely for in vitro health screenings because part of the sample (the supernatant containing plasma or serum that is platelet rich) is returned to the person's body.

In a particular example, platelet-rich fibrin applications in dental procedures is becoming increasingly popular due to expedited healing. Other applications include hair loss, wrinkle and antiaging, and orthopedic treatments. These treatments typically require multiple sessions. Multiple sessions also means greater exposure to additives from plastic tubes.

Plastic test tubes are generally treated with silicones and silicas. Inhalation and internal exposure to silicas can result in fibroids and subsequently cancer. Exposure to the additives likely poses an industrial occupational hazard for those in the manufacturing sector. People receiving treatments with their own serum or plasma are exposed to additive residue, sometimes directly into the bloodstream if the serum or plasma is injected or topically applied to an open wound or suture. Furthermore, hormone disruptors such as bisphenol A can leach from the plastic in to the sample and supernatant to be used in treatment.

Accordingly, sample exposure to additives as inherently occurring with plastic tubes should be avoided or eliminated while still conforming to government regulations.

### SUMMARY OF THE DISCLOSURE

What is needed is a cost-effective durable device to be used in connection with a breakable inner container at least partially filled with a sample. A device generally comprises an inner container housed in the cavity of an outer protective body. The outer protective body may be fixably or removably attached to the inner container.

The inner container is capable of holding a sample which may be a bodily fluid such as blood or serum, a soil or water sample, a pharmaceutical preparation, or a nutritional product. The inner container is configured to fit inside an internal cavity defined by the outer protective body.

A lid prevents contamination or expulsion of a sample disposed within the inner container. The lid is configured to be securable upon the upper end of the outer protective body while providing a vacuum seal as well as positional stabilization for the inner container. The lid is configured to be frictionally secured over the upper end of the outer protective body. The frictional security provides enhanced stability and contamination prevention for the device for protecting an inner container.

The outer protective body has a ledge disposed at an upper end thereof. The ledge is configured to securely receive the lid thereon. This embodiment provides an efficient manner of holding the lid on the device for protecting an inner container and sample. A strap can be implemented to secure an inner container with its own lid or cap where the outer protective body does not receive the lid or cap thereon.

The device may be presented in a sterile pack for single or multi use after autoclaving. Multiple devices may be presented in a single sterile pack and may be configured according to the intended application. For example, specialized packs may be configured for platelet-rich fibrin applications in dental and oral surgical procedures.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure.

FIG. 1 shows an exploded view of an exemplary device for protecting an inner container.

FIG. 2 shows a perspective view of an exemplary device for protecting an inner container.

FIG. 3 shows a side sectional view of an exemplary device for protecting an inner container.

FIG. 4 shows an additional side sectional view of an exemplary device for protecting an inner container.

FIG. 5 shows an enlarged side sectional view of an open end of an exemplary device for protecting an inner container.

FIG. 6 shows a perspective view of an exemplary device for protecting an inner container in a sterile pack.

FIG. 7 shows a side sectional view of an exemplary device for protecting an inner container.

FIG. 8 shows an exploded view of an exemplary device for protecting an inner container with a strap.

### REFERENCE NUMERALS OF THE DRAWINGS

10 device
11 inner container
12 outer protective body
13 housing
14 internal cavity
15 open end
16 rim
17 elongated tubular housing
18 open upper end
19 lip
20 ledge
21 wall
22 lid
23 base
24 receptacle
25 cap
26 first seal
27 second seal
28 strap
29 ridge
30 connection point
32 fastener
33 sterilized housing
34 void
40 strap
41 fastener
42 closed end

### DETAILED DESCRIPTION

The present disclosure provides generally for a device for protecting an inner container, especially for use in industries such as biomedical science, health care, dentistry, agriculture, industrial, and veterinary health and wellness.

According to the present disclosure, a device generally comprises an inner container housed in the cavity of an outer protective body. The outer protective body may be fixably or removably attached to the inner container. The inner container is capable of holding a sample which may be bodily fluid such as blood or serum, a soil or water sample, a pharmaceutical preparation, or a nutritional product.

In preferred embodiments, the inner container is made of a glass such as borosilicate for example, and the outer protective body is made out of a molded or extruded plastic such as polyethylene terephthalate (“PET”). In preferred embodiments, the outer protective body is translucent or transparent to allow visibility of the sample in the inner container. The glass inner container provides compatibility with the sample for storage and processing while the plastic outer protective body prevents breakage of the inner container and destruction and contamination of the sample.

In preferred embodiments, the outer protective body may be removed and autoclaved for interchangeable or recycled use. However, in some embodiments, the outer protective body may be fixably attached to an inner container for single use. The protective body is preferably configured to fit in standard centrifuges and test tube holders.

In preferred embodiments and under sterile conditions, a lid and/or a cap applied will create a vacuum seal yet provide penetration of a needle into the inner container to retrieve a sample. The sample may then be further processed, applied to or within an animal's body, or used for in vitro experimentation.

Specialized sterile packs may be customized according to the intended application. For example, dental and oral surgery procedures using platelet-rich fibrin may require one to six devices in a sterile pack for single use whereas environmental applications may require a pack of twelve tubes for various sample sites.

Preferably, the device should be treated like any other collection or test tube with safety precautions such as placing the device in a holder when not in use or when placing an inner container, cap, lid, or strap on or into the device's outer container.

A sample may comprise a solid, liquid, or gas. A sample may be deposited into the inner container before or after the inner container is inserted into the outer container or protective body if the outer protective body is removably attached.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

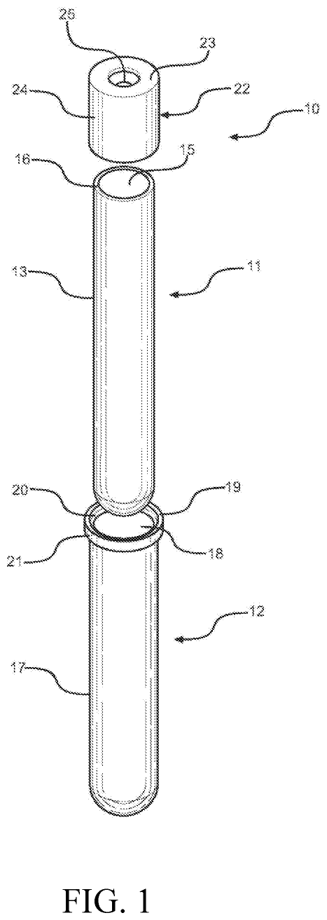

Referring to FIG. 1, an exploded view of an exemplary device for protecting an inner container is shown. The device for protecting an inner container 10 (“the device”) comprises an inner container 11 and an outer protective body 12. In the shown embodiment, the inner container 11 comprises an elongated tubular housing 13 defining an internal cavity 14 therein with an open end 15 disposed oppositely a closed lower end. The lower end is of any suitable shape. Additionally, in the illustrated embodiment, the closed lower end is rounded. The open upper end 15 is defined by a rim 16.

Furthermore, the inner container 11 is configured to receive a biological, medical, fluids, food or chemical sample therein. The inner container 11 is made of a non-contaminating material. In one embodiment, the inner container 11 is made of glass. When using glass, blood coagulation is promoted in the cavity 14 wherein the biological, medical or chemical sample is a blood sample.

In another embodiment, the inner container 11 further comprises at least one additive, such as an SFS coating, a gel, a clot activator, a separator or an anticoagulant compound. In another embodiment, the inner container 11 is vacuum-sealed by a cap 25 which may secure a lid 22 or be independent therefrom depending on the type of inner container used such as a standard tube or a vacuum sealed tube. The inner container 11 may be any container configured to receive a sample therein.

In one embodiment, the inner container is configured to be processed in a centrifuge when assembled with the outer protective body 12. In another embodiment, the inner container is configured to be used in the manufacture of platelet rich fibrin (PRF). In yet another embodiment, the inner container is configured to be used in In Vitro Diagnostic (IVD) tests. In another embodiment, the outer protective body 12 comprises an elongated tubular housing 17 defining a cavity therein with an open upper end 18. The open upper end 18 is defined by a lip 19.

The outer protective body 12 is configured to house the inner container 11 therein. The outer protective body 12 is configured to prevent breakage of the inner container 11. The outer protective body 12 is made of a shatter-resistant material, such as polyethylene terephthalate (PET), plastic, latex, ceramic, fiberglass, metal, flexi-glass, rubber, melamine, tempered glass, polypropylene, carton, glazed stoneware, metallic glass, or a combination of the above materials. The outer protective body 12 is further configured to be shock-resistant, meaning that the outer protective body 12 can sustain an impact without damage to an internal component, such as the inner container 11 or the biological, medical or chemical sample disposed therein, and liquids and food or other consumable sample. In one embodiment, the inner container 11 is longer in length, from the rim to the bottom, than the outer protective body 12, such that a portion of the inner container 11 extends above the lip 19 of the outer protective body 12. The lip 19 defines a ledge 20 with a wall 21 extending upward therefrom. When the device for protecting a sample 10 is placed in a vertical position, the ledge 20 is oriented on a horizontal axis and the wall 21 is oriented on a vertical axis. The outer protective body 12 is sized to receive the inner container 11 in the cavity thereof

For example, the outer protective body may be 15 centimeters long and the inner container may be 10 or 12 centimeters long. In another example, the outer protective body and the inner container may be the same length. Conventional sizes and shapes may be implemented.

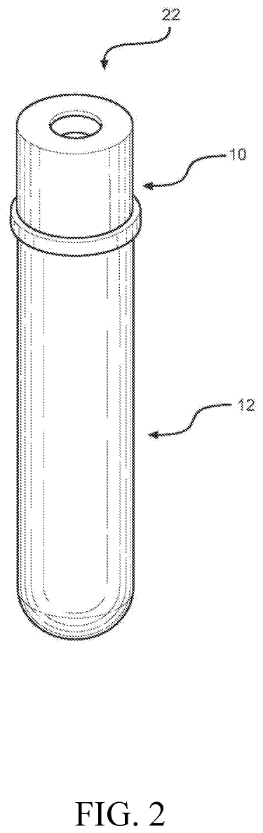

Referring to FIG. 2, a perspective view of an exemplary device for protecting an inner container is shown. The device for protecting an inner container 10 is configured to be arranged in a containment position and an open position. The containment position is defined where the inner container is removably disposed within the outer protective body 12. Furthermore, in the containment position, the lid 22 is engaged upon the outer protective body 12, such as to ensure that the biological, medical or chemical sample will not leak in the unlikely yet possible event the inner container breaks.

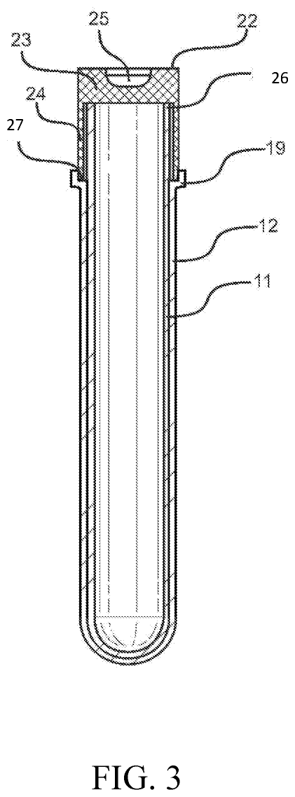

Referring to FIG. 3, a side sectional view of an exemplary device for protecting an inner container is shown. The outer protective body 12 comprises an interface configured to receive a cap 25. Under the shown embodiment, the cap 25, or alternatively a lid 22 depending on configuration, may attach to the outer protective body 12 and aligns with the lip 19 disposed on an upper portion of the outer protective body 12. This embodiment ensures that fluid will not escape from the cavity of the inner container 1 as a first seal 26 is formed between the inner container 11 and an internal side of the base 23 of the lid 25. Additionally, a second seal 27 is formed between the outer protective body 12 and the cap 25 or lid 22 at the lip 19.

In the illustrated embodiment, the lid 22 is vertically lower than the periphery of the cap 25 disposed around the lid 22. Under this embodiment, the indent is easier to locate and is easier to penetrate with a needle. Alternatively and depending on the configuration of the inner container, the cap 25 may be vertically lower than the lid 22. Clearances may be by 0.2 mm to 2 cm for example.

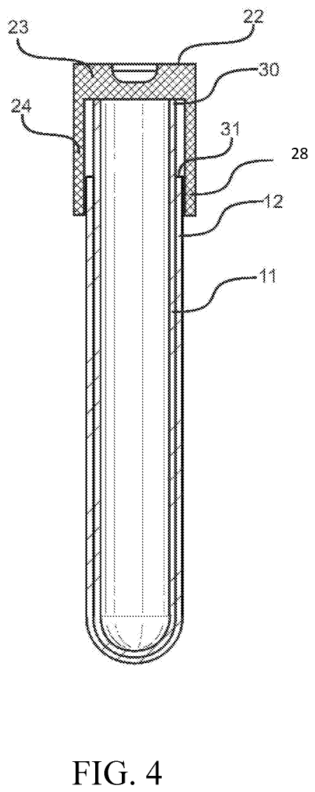

Referring to FIG. 4, an additional side sectional view of an exemplary device for protecting an inner container is shown. Under the shown embodiment, the lid is frictionally secured to the device for protecting a sample. A first seal 26 is frictionally formed between the inner container 11 and the base 23 of the lid 22. Additionally, a second seal 27 is frictionally formed between the outer protective body 12 and an overlapping portion 40 of the receptacle 24 of the lid 22.

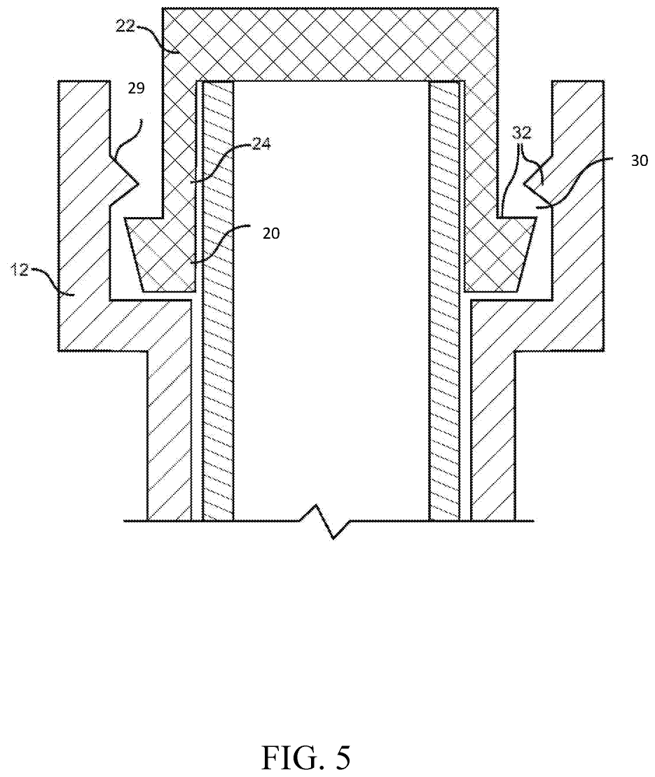

Referring to FIG. 5, an enlarged side sectional view of an open end of an exemplary device for protecting an inner container is shown. In one embodiment, the device for protecting a sample comprises a fastener 32 disposed between the connection point 30 of the lid 22 and the outer protective body 12.

In the illustrated embodiment, the fastener comprises a ridge 29 and a ledge 20. The ridge 29 is disposed on the internal surface of the outer protective body 12. The ledge 20 is disposed on the external surface of the receptacle 24. When the device for protecting a sample is placed into a locked position, the ledge 20 will pass under the ridge 29, such that the lid will be frictionally secured to the outer protective body 12.

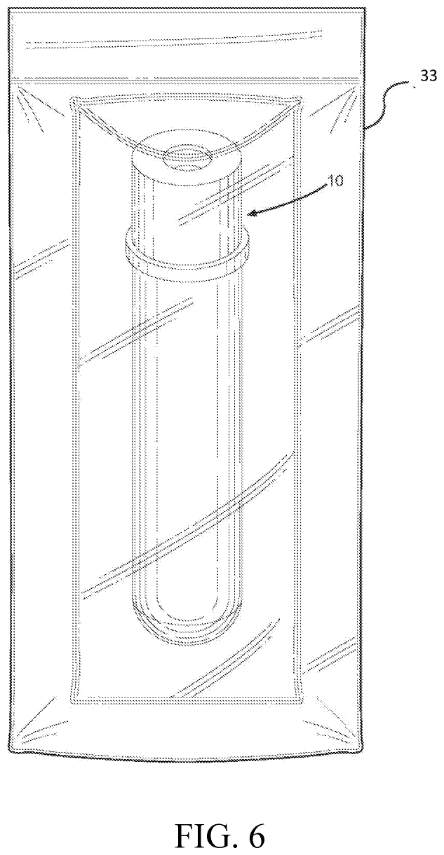

Referring to FIG. 6, a perspective view of an exemplary device for protecting an inner container in a sterile pack is shown. In one embodiment, the sterilized housing 33 is configured to receive the inner container, the outer protective body and the lid therein. By packaging the device for protecting a sample 10 in the sterilized housing 33, it is ensured that the device for protecting a sample will be sterile when used. In the illustrated embodiment, the sterilized housing 33 is transparent. The sterilized housing 33 is made of any suitable material, such as plastic.

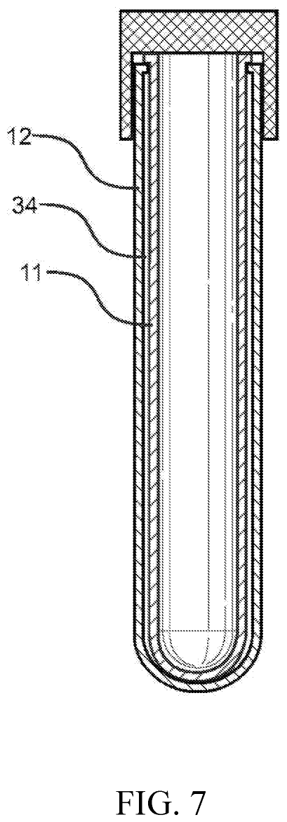

Referring to FIG. 7, a side sectional view of an exemplary device for protecting an inner container is shown. In one embodiment, a void 34 is defined between the inner container 11 and the outer protective body 12. The void 34 may be of any desired size. In one embodiment, the space 34 extends entirely between the inner container 11 and the outer protective body 12. In another embodiment, the void 34 is at least partially filled with a solid, a liquid or a gas.

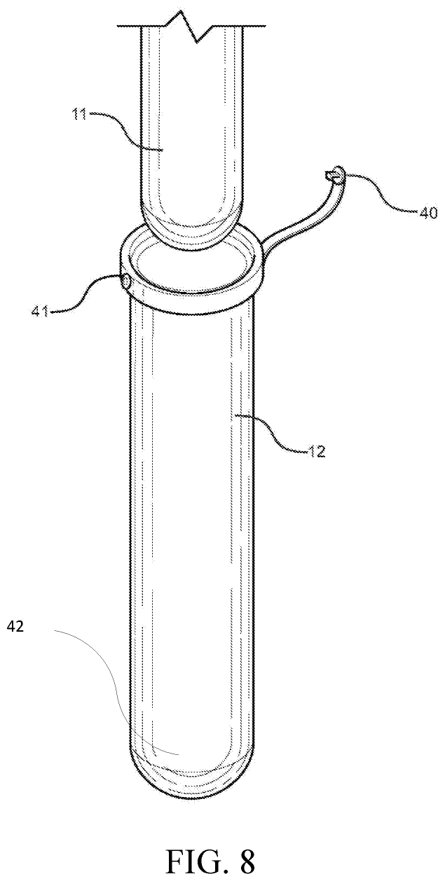

Referring to FIG. 8 an exploded view of an exemplary device for protecting an inner container with a strap is shown. Under the shown embodiment, the outer protective body 12 comprises a strap 40 disposed on an end thereof, preferably opposite a closed end 42. The strap 40 is configured to interact with a fastener 41, such that the inner container 11 can be secured in the outer protective body 12 by the strap. This configuration allows for a greater variety of inner containers to be used with the device. The device's outer body may be made from a material selected from the group consisting of polyethylene terephthalate, plastic, latex, ceramic, fiberglass, metal and any breakage-resistant material.

The device may be used with inner containers made from glass, ceramic, porcelain, plastics and may also have additives such as SFS, a coating, a gel, a clot activator, a surfactant, a separator, or an anticoagulant compound.

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. Nevertheless, it will be understood that various modifications may be made without departing from the spirit and scope of the claimed disclosure.

What is claimed is:

1. A device for protecting an inner container, the device comprising:
an outer protective body;
wherein the outer protective body defines an internal cavity with an open end;
wherein the outer protective body is configured to house an inner container therein;
wherein the outer protective body is configured to prevent breakage of the container.

2. The device according to claim 1 further comprising an inner container.

3. The device for protecting an inner container of claim 2, wherein the inner container is removably disposed in the internal cavity of the outer protective body.

4. The device according to claim 2, wherein the inner container is fixably attached in the internal cavity of the outer protective body.

5. The device according to claim 1, wherein the outer protective body comprises an interface configured to receive a lid.

6. The device according to claim 2, wherein the inner container includes an interior volume that is vacuum-sealed by a lid.

7. The device according to claim 2, wherein the outer protective body is sized at a height less than the height of the inner container.

8. The device according to claim 2 wherein the outer protective body is sized at a height equal to the height of the inner container.

9. The device according to claim 2 wherein the outer protective body is sized at a height greater than the heights of the inner container.

10. The device according to claim 6, wherein the lid is configured to cooperatively engage with the outer protective body to concentrically form a seal between the outer protective body and the inner container

11. The device according to claim 2, wherein a void is defined between the outer protective body and the inner container.

12. The device according to claim 11 wherein the void is at least partially filled with a solid, liquid, or gas.

13. The device according to claim 1, wherein the outer protective body is made of a material selected from the group consisting of polyethylene terephthalate, plastic, latex, ceramic, fiberglass, metal and any breakage-resistant material.

14. The device according to claim 6, wherein the lid comprises an indent configured to be pierced with a needle.

15. The device according to claim 2, wherein the outer protective body, the inner container and a lid are disposed in a sterilized housing.

16. The device for protecting a sample of claim 2, wherein the inner container comprises an additive.

17. The device according to claim 2, wherein the additive comprises an SFS, a coating, a gel, a clot activator, a surfactant, a separator, or an anticoagulant compound.

18. The device according to claim 2, wherein the device is configured to be processed in a centrifuge when assembled.

19. The device according to claim 2, wherein the inner container is configured to be used for the separation of platelet rich fibrin clot.

20. The device according to claim 3, further comprising a strap and a fastener disposed on a top portion of the outer protective body, wherein the strap is configured to fasten over the open end of the outer protective body.

21. The device according to claim 2, wherein the inner container is made of glass or PET.

22. The device according to claim 6, further comprising a ridge disposed on an internal surface of the lid and a ledge disposed on the external surface of the outer protective body, the ridge configured to couple with the ledge.

23. The device for protecting a sample of claim 7, wherein an impact reduction substance is disposed in a void.
